(19) United States
(12) Patent Application Publication
(10) Pub. No.: US 2026/0201163 A1
(43) Pub. Date: Jul. 16, 2026

(54) PHOTOCURABLE RESIN COMPOSITION

(71) Applicant: THREEBOND CO., LTD., Tokyo (JP)

(72) Inventor: Chiaki MATSUI, Hachioji-shi, Tokyo (JP)

(21) Appl. No.: 19/136,623

(22) PCT Filed: Oct. 25, 2023
(86) PCT No.: PCT/JP2023/038456

§ 371 Date: Jun. 6, 2025

(30) Foreign Application Priority Data
Dec. 14, 2022 (JP) 2022-199425

(51) Int. Cl. C08L 71/00; C08G 81/02; C08K 3/04; C08K 5/375; C08K 5/544

(52) U.S. Cl. CPC C08L 71/00; C08G 81/025; C08K 3/04; C08K 5/375; C08K 5/5477; C08L 2205/03; C08L 2205/05

(57) ABSTRACT

CROSS REFERENCE TO RELATED APPLICATION

This Application is a 371 of PCT/JP2023/038456 filed on Oct. 25, 2023, which in turns claims the priority of Japanese Patent Application No. 2022-199425, filed on Dec. 14, 2022, all of which are incorporated herein by reference.

### TECHNICAL FIELD

The present invention relates to a photocurable resin composition that is excellent in surface curability even when colored and can provide a cured product excellent in tensile strength.

### BACKGROUND ART

Conventionally, curable resin compositions that can be cured by moisture in the air without the need for applying heat to members have been known, and have been often used as adhesives, sealing agents, coating agents, and the like. However, such curable resin compositions have had the problem that curing by moisture in the air cause unintended reactions to proceed during storage or working and that productivity are poor when used as adhesives, sealing agents, coating agents, and the like. JP 2008-274119 A discloses a curable composition comprising a vinyl-based polymer having, on average, at least one crosslinkable silyl group at its terminal and a compound that generates an acid or base when irradiated with light. It discloses that this curable composition has excellent storage stability and can ensure working time because it is cured by irradiation with active energy rays such as ultraviolet rays.

### SUMMARY OF INVENTION

### Technical Problem

However, the conventional curable resin compositions have had the problem that when the resin is colored for purpose of concealing the wiring of parts, and the like, the acceleration of curing by irradiation with active energy rays is inhibited, which affects the curing properties. On the other hand, the resin composition which can be cured by heating with the addition of a thermal acid generator is known, but it has had the problem that it cannot be used for members that cannot be heated.

### Solution to Problem

After diligent research to achieve the, the present inventor has found a technique relating to a photocurable resin composition that is excellent in surface curability only by photocuring even when colored and can provide a cured product excellent in tensile strength, and has completed the present invention.

The gist of the present invention will be described below:
[1] A photocurable resin composition comprising the following components (A) to (D):
   component (A): an organic polymer having two or more alkoxysilyl groups in one molecule;
   component (B): a compound having an isocyanuric ring and an alkoxysilyl group in one molecule;
   component (C): a pigment; and
   component (D): a photoacid generator.
[2] The photocurable resin composition according to [1], wherein the component (A) comprises an organic polymer having a polyether skeleton and having two or more alkoxysilyl groups in one molecule.
[3] The photocurable resin composition according to [1] or [2], wherein the component (A) comprises an organic polymer having a polyether skeleton and having two or more alkoxysilyl groups in one molecule and an organic polymer having a vinyl-based polymer skeleton and having two or more alkoxysilyl groups in one molecule.
[4] The photocurable resin composition according to any of [1] to [3], wherein the component (C) is carbon black.
[5] The photocurable resin composition according to any of [1] to [4], wherein the component (D) is an onium salt compound.
[6] The photocurable resin composition according to any of [1] to [5], wherein the component (D) is a sulfonium salt compound.
[7] The photocurable resin composition according to any of [1] to [6], wherein the component (B) is tris(3-trimethoxysilylpropyl) isocyanurate.
[8] A cured product obtained by curing the photocurable resin composition according to any of [1] to [7].
[9] The cured product according to [8], having a total light transmittance of 0.1% or less and a tensile strength of 0.4 MPa or more.

### Effect of Invention

The present invention provides a photocurable resin composition that is excellent in surface curability even when colored and can provide a cured product excellent in tensile strength.

### DESCRIPTION OF EMBODIMENTS

The details of the present invention will be described below. In the present specification, the term “X to Y” is used to mean that the numerical values (X and Y) described before and after the term are included as a lower limit value and an upper limit value and means “X or more and Y or less”. In the present specification, the term “(meth)acrylic” refers to both acrylic and methacrylic.

Component (A) to be used in the present invention is an organic polymer having two or more alkoxysilyl groups in one molecule. The alkoxysilyl group may be bonded to the terminal or side chain of the organic polymer, but it is preferably bonded to the terminal from the viewpoint of excellent curing properties of the photocurable resin composition. Component (A) is preferably liquid at 25° C., from the viewpoint of handling. The viscosity (25° C.) of component (A) is not particularly limited, but it is preferably 0.1 to 1000 Pa·s, more preferably 0.3 to 500 Pa·s, and particularly preferably 0.5 to 200 Pa·s. When the viscosity of component (A) is 0.1 Pa·s or more, the composition has excellent deep curability, whereas when the viscosity of component (A) is 1000 Pas or less, the composition has low viscosity and therefore excellent workability.

The alkoxysilyl group is a group having one to three alkoxy groups bonded to a silicon atom, and examples of the alkoxy group include a methoxy group, an ethoxy group, a propyloxy group, an isopropyloxy group and a butoxy group. From the viewpoint of excellent surface curability, an alkoxysilyl group having three alkoxy groups bonded to a silicon atom is preferred, and the alkoxy group is preferably a methoxy group. That is, a trimethoxysilyl group is most preferred.

The main chain structure of the above component (A) is not particularly limited, but examples thereof include a polyether skeleton, a polyester skeleton, a polycarbonate skeleton, a polyalkylene skeleton, a polyurethane skeleton, a polyamide skeleton, a polyurea skeleton, a polyimide skeleton and vinyl-based polymer skeleton. Among these, a polyether skeleton or a vinyl-based polymer skeleton are preferred from the viewpoint of excellent curability and tensile strength. These may be used alone or in combination of two or more thereof, but the combined use of an organic polymer having a polyether skeleton and an organic polymer having a vinyl-based polymer skeleton is more preferred, and the combined use of an organic polymer having a polyether skeleton and an organic polymer having an acrylic polymer skeleton is most preferred.

For the commercially available organic polymer having two or more alkoxysilyl groups in one molecule, examples of the organic polymer having a polyether skeleton include the Sairil (registered trademark) series SAT200, SAT350, SAT400, SAX720, SAX750, SAX510, SAX530 and SAX575 (manufactured by KANEKA CORPORATION); examples of the organic polymer having a vinyl-based polymer skeleton include the EPION (registered trademark) series EP100S, EP103S, EP303S and EP505S (manufactured by KANEKA CORPORATION), and the XMAP series SA100S, SA110S, SA120S, OR100S and OR110S (manufactured by KANEKA CORPORATION); and examples of the mixture of the organic polymer having a polyether skeleton and the organic polymer having a vinyl-based polymer skeleton include MA410, MA451 and MA480 (manufactured by KANEKA CORPORATION). These may be used alone or in combination of two or more thereof.

Component (B) to be used in the present invention is a compound having an isocyanuric ring and an alkoxysilyl group in one molecule. For unclear reason, the addition of component (B) can provide a photocurable resin composition excellent in surface curability and tensile strength. Examples of component (B) include, but not particularly limited to, tris(3-trimethoxysilylmethyl) isocyanurate, tris(3-trimethoxysilylpropyl) isocyanurate, tris(3-triethoxysilylmethyl) isocyanurate, tris(3-triethoxysilylpropyl) isocyanurate, and 1-(3-(trimethoxysilyl) propyl) 3,5-di-2-propenyl-1,3,5-triazine-2,4,6 (1H,3H,5H)-trione. These may be used alone or in combination of two or more thereof, but tris(3-trimethoxysilylpropyl) isocyanurate or 1-(3-(trimethoxysilyl) propyl) 3,5-di-2-propenyl-1,3,5-triazine-2,4,6 (1H,3H,5H)-trione is preferred, and tris(3-trimethoxysilylpropyl) isocyanurate is most preferred, from the viewpoint of excellent surface curability and tensile strength.

Examples of the commercially available product of component (B) include, but are not limited to, KBM-9659 and X-12-1290 (manufactured by Shin-Etsu Chemical Co., Ltd.).

The content of the component (B) is not particularly limited, but it is preferably 1 to 50 parts by mass, more preferably 3 to 30 parts by mass, even more preferably 5 to 20 parts by mass, and most preferably 7 to 15 parts by mass, based on 100 parts by mass of Component (A). When the content is 1 part by mass or more, the photocurable resin composition excellent in surface curability and tensile strength can be obtained, whereas when the content is 50 parts by mass or less, the photocurable resin composition excellent in storage stability can be obtained.

Component (C) to be used in the present invention is a pigment. Among the pigments, a black pigment is preferred from the viewpoint of excellent concealability. Examples of the black pigment include carbon black, black titanium oxide, copper chrome black, cyanine black and aniline black. Among them, carbon black is preferred from the viewpoint of concealability and dispersibility in Component (A) of the present invention. These may be used alone or in combination of two or more thereof. The above-described Component (C) that has been dispersed in a reactive resin or a plasticizer in advance is preferably used, from the viewpoint of dispersibility.

Examples of the reactive resin capable of dispersing component (C) include component (A) described above, and an organic polymer having one alkoxysilyl group in one molecule (including the silane coupling agent described later).

The plasticizer capable of dispersing component (C) is not particularly limited, but it is preferably a phenyl alkylsulfonate ester or a polyoxyalkylene alkyl ether is preferred, from the viewpoint of not affecting the storage stability of the photocurable resin composition.

The content of the component (C) is not particularly limited, but it is preferably 0.1 to 50 parts by mass, more preferably 0.3 to 30 parts by mass, and most preferably 0.5 to 20 parts by mass, based on 100 parts by mass of component (A). When the content is 0.1 parts by mass or more, the concealability can be provided to a resin, whereas the content is 50 parts by mass or less, the curability is not affected.

Component (D) to be used in the present invention is a photoacid generator. The photoacid generator is a compound that can release an acidic substance capable of crosslinking component (A) by irradiation with active energy rays. Examples of the photoacid generator include an onium salt compound and a sulfonic acid ester compound, but it is preferably an onium salt compound and particularly preferably a sulfonium salt, from the viewpoint of excellent curability. These may be used alone or in combination of two or more thereof. The above-described component (D) that has been dissolved in a solvent such as an organic solvent in advance may be used, from the viewpoint of compatibility.

Examples of the onium salt compound that can be used in the present invention include, but not particularly limited to, an iodonium salt or a sulfonium salt having an anion such as a hexafluoroantimonate ion, a tetrafluoroborate ion, a hexafluorophosphate ion, a hexafluoroarsenate ion, hexachloroantimonate ion, a trifluoromethanesulfonate ion, and a fluorosulfonate ion. Specific examples thereof include diphenyl (4-phenylthio)phenylsulfonium hexafluorophosphate, diphenyl [4-(phenylthio)phenyl]sulfonium hexafluoroantimonate (V), diphenyl [4-(phenylsulfanyl)phenyl] sulfonium trifluorotris (pentafluoroethyl)-25-phosphanuide, [4-(1-methylethyl)phenyl] (4-methylphenyl) iodonium and trifluorotris (1,1,2,2,2-pentafluoroethyl) phosphate, and diphenyl [4-(phenylsulfanyl)phenyl] sulfonium trifluorotris (pentafluoroethyl)-λ⁵-phosphanuide is preferred from the viewpoint of reactivity.

Examples of the commercially available onium salt compound include CPI-100P, CPI-101P, CPI-200K, CPI-210S and IK-1 (manufactured by San-Apro Ltd.); WPI-113, WPI-116, WPI-169, WPI-170, WPAG-336, WPAG-367, WPAG-370, WPAG-469 and WPAG-638 (manufactured by FUJIFILM Wako Pure Chemical Corporation); ADEKA Optomers SP-150, SP-151, SP-170, SP-171 and SP-172 (manufactured by ADEKA CORPORATION); Irgacure (registered trademark) 250 (manufactured by BASF); CD-1010, CD-1011 and CD-1012 (manufactured by Sartomer); and San-Aid (registered trademark) SI-60, SI-80, SI-100, SI-60L, SI-80L, SI-100L, SIL145, SI-L150, SI-L160, SI-L110 and SI-L147 (manufactured by SANSHIN CHEMICAL INDUSTRY CO., LTD.).

Examples of the sulfonic acid ester compound that can be used in the present invention include, but not particularly limited to, 1,8-naphthalimide trifluoromethanesulfonate, 1,8-naphthalimide nonafluorobutanesulfonate, 1,8-naphthalimide perfluorooctanesulfonate, 1,8-naphthalimide pentafluorobenzenesulfonate, 1,3,6-trioxo-3,6-dihydro-1H-11-thia-azacyclopentaanthracen-2-yl nonafluorobutanesulfonate ester, 8-isopropyl-1,3,6-trioxo-3,6-dihydro-1H-11-thia-2-azacyclopentaanthracen-2-yl nonafluorobutanesulfonate ester, 1,2-naphthoquinone-2-diazido-5-sulfonic chloride, 1,2-naphthoquinone-2-diazido-4-sulfonic chloride, 1,2-benzoquinone-2-diazido-4-sulfonic chloride, sodium 1,2-naphthoquinone-2-diazido-5-sulfonate, sodium 1,2-naphthoquinone-2-diazido-4-sulfonate, sodium 1,2-benzoquinone-2-diazido-4-sulfonate, potassium 1,2-naphthoquinone-2-diazido-5-sulfonate, potassium 1,2-naphthoquinone-2-diazido-4-sulfonate, potassium 1,2-benzoquinone-2-diazido-4-sulfonate, methyl 1,2-naphthoquinone-2-diazido-5-sulfonate, and methyl 1,2-benzoquinone-2-diazido-4-sulfonate.

Examples of the commercially available sulfonic acid ester compound include SIN-11 (manufactured by SANBO CHEMICAL INDUSTRY CO., LTD.) and NT-1TF (manufactured by San-Apro Ltd.).

The content of the component (D) is not particularly limited, but it is preferably 0.1 to 20 parts by mass, more preferably 0.5 to 10 parts by mass, and most preferably 0.8 to 5 parts by mass, based on 100 parts by mass of component (A). When the content is 0.1 parts by mass or more, the curability of the resin can be maintained, whereas the content is 20 parts by mass or less, the storage stability is not affected.

In addition, various additives may be added to the photocurable resin composition of the present invention, to the extent that the properties of the photocurable resin composition of the present invention are not impaired. Examples of the additive include a filler, a photo-radical polymerization initiator, a sensitizing agent, a solvent, a plasticizer, a curing catalyst, a thermal acid generator, a silane coupling agent (except for component (B)), a preservative stabilizer, an antioxidant, an ultraviolet absorber, a surfactant, a dispersing agent, an anti-foam agent, a thickening agent, a flame retardant, a lubricant and a foaming agent.

Examples of the filler include fumed silica, precipitated silica, crystalline silica, fused silica, dolomite, calcium carbonate, talc, clay and glass balloon. Amont them, fumed silica is preferred because of its excellent reinforcing properties. Silica the surface of which has been hydrophobically treated in advance with an organosilicon compound such as an organosilane or an organosilazane may also be used. These may be used alone or in combination of two or more thereof. When the filler is added, the amount of the filler to be blended is 0.1 to 300 parts by mass, preferably 0.3 to 100 parts by mass, and particularly preferably 0.5 to 50 parts by mass, based on 100 parts by mass of component (A) of the present invention.

Examples of the commercially available fumed silica include, but not particularly limited to, an untreated fumed silica such as AEROSIL (registered trademark) 90, AEROSIL 130, AEROSIL 150, AEROSIL 200, AEROSIL 300, AEROSIL 380, AEROSIL OX50, AEROSIL EG50 or AEROSIL TT600 (manufactured by NIPPON AEROSIL CO., LTD.); and a hydrophobically treated fumed silica such as AEROSIL R972, AEROSIL R974, AEROSIL R976, AEROSIL R104, AEROSIL R106, AEROSIL R202, AEROSIL R805, AEROSIL R812, AEROSIL R812S, AEROSIL R816, AEROSIL R7200, AEROSIL R8200, AEROSIL R9200, AEROSIL RY50, AEROSIL NY50, AEROSIL RY300, AEROSIL RY200 or AEROSIL RY200S (manufactured by NIPPON AEROSIL CO., LTD.).

The fumed silica having an average particle size of 1 nm or more and 30 μm or less is preferably used. The fumed silica having an average particle size of primary particles of 1 nm or more and 50 nm or less is more preferably used, since it has a particularly high reinforcing effect.

The photo-radical polymerization initiator can be used, for example, in combination with component (D) of the present invention to improve the curability. Specific examples include an acetophenone compound such as diethoxyacetophenone, 2-hydroxy-2-methyl-1-phenylpropan-1-one, benzyl dimethyl ketal, 4-(2-hydroxyethoxy)phenyl-(2-hydroxy-2-propyl) ketone, 1-hydroxycyclohexyl phenyl ketone, 2-methyl-2-morpholino (4-thiomethylphenyl) propan-1-one, 2-benzyl-2-dimethylamino-1-(4-morpholinophenyl) butanone or 2-hydroxy-2-methyl-1-[4-(1-methylvinyl)phenyl] propanone oligomer; a benzoin compound such as be benzoin, benzoin methyl ether, benzoin ethyl ether, benzoin isopropyl ether or benzoin isobutyl ether; a benzophenone compound such as benzophenone, methyl o-benzoylbenzoate, 4-phenylbenzophenone, 4-benzoyl-4′-methyl-diphenyl sulfide, 3,3′,4,4′-tetra (t-butylperoxycarbonyl)benzophenone, 2,4,6-trimethylbenzophenone, 4-benzoyl-N,N-dimethyl-N-[2-(1-oxo-2-propenyloxy)ethyl]benzenemethanaminium bromide or (4-benzoylbenzyl) trimethylammonium chloride; a thioxanthone compound such as 2-isopropylthioxanthone, 4-isopropylthioxanthone, 2,4-diethylthioxanthone, 2,4-dichlorothioxanthone, 1-chloro-4-propoxythioxanthone or 2-(3-dimethylamino-2-hydroxy)-3,4-dimethyl-9H-thioxanthon-9-one mesochloride; and an acylphosphine oxide compound such as diphenyl(2,4,6-trimethylbenzoyl) phosphine oxide. Among these, an acetophenone compound and an acylphosphine oxide compound are preferred. These may be used alone or in combination of two or more thereof. When a radical polymerization initiator is added, the amount of the radical polymerization initiator to be blended is preferably 0.1 to 20 parts by mass based on 100 parts by mass of component (A) of the present invention.

Examples of the sensitizing agent include an anthracene compound, a pyrene compound, an anthraquinone compound, a thioxanthone compounds, a fluorenone compounds and coloring matter. These may be used alone or in combination of two or more thereof. When a sensitizing agent is added, the amount of the sensitizing agent to be blended is 0.1 to 50 parts by mass, preferably 0.3 to 20 parts by mass, and more preferably 0.5 to 10 parts by mass, based on 100 parts by mass of component (A) of the present invention.

Examples of the solvent include an aliphatic hydrocarbon solvent, an aromatic hydrocarbon solvent, an alicyclic hydrocarbon solvent, an alcohol-based solvent, an aldehyde-based solvent, a ketone-based solvent, ester-based solvent, an ether-based solvent, a carbonate-based solvent and a petroleum-based solvent. These may be used alone or in combination of two or more thereof. When the solvent is added, the amount thereof to be blended is 25 to 200 parts by mass, preferably 50 to 150 parts by mass, and more preferably 75 to 125 parts by mass, based on 100 parts by mass of component (D) of the present invention.

Examples of the plasticizer include a process oil, a liquid hydrocarbon compound such as a poly-xx-olefin, a phosphoric acid ester compound, a sulfonic acid ester compound, a phthalic acid ester compound and a polyether compound. These may be used alone or in combination of two or more thereof. The component (C) may be dissolved therein in advance.

The curing catalyst is not particularly limited as long as it is a catalyst that crosslinks component (A). Specific examples of the curing catalyst include a tin compound such as dibutyltin dilaurate, dibutyltin oxide, dibutyltin diacetate, dibutyltin distearate, dibutyltin laurate oxide, dibutyltin diacetylacetonate, dibutyltin dioleylmalate, dibutyltin octoate, dioctyltin oxide or dioctyltin dilaurate; a titanate-based compound such as a metal complex such as tetra-n-butoxytitanate or tetraisopropoxytitanate; a metal carboxylate such as lead octylate, lead naphthenate, nickel naphthenate, and cobalt naphthenate, and a metal carboxylate of a zinc-based compound, an iron-based compound, bismuth, or the like; and a metal acetylacetonate complex such as an aluminum acetylacetonate complex or a vanadium acetylacetonate complex. An amine salt such as dibutylamine 2-ethylhexoate; an organophosphoric acid compound such as monomethyl phosphoric acid or di-n-butyl phosphoric acid; and other acidic and basic catalysts can also be used. These may be used alone or in combination of two or more thereof, but the photocurable resin composition preferably comprises no curing catalyst, due to concerns that the reaction would occur gradually, resulting in an increase in viscosity.

The thermal acid generator accelerates curing by applying heat. However, when used for a member that cannot be heated, the thermal acid generator does not accelerate curing but serves as impurities, and therefore, the photocurable resin composition preferably comprises no thermal acid generator.

The preservative stabilizer is not particularly limited as long as it absorbs or reacts with moisture contained in the photocurable resin composition (except for component (B)). Examples of the preservative stabilizer include a tetrafunctional alkoxysilane such as tetramethoxysilane or tetraethoxysilane, and a hydrolysate thereof; methyltrimethoxysilane and methyltriethoxysilane and hydrolysates thereof; and a silicate compound represented by methylsilicate, ethylsilicate, propylsilicate and butylsilicate, and oligomers thereof. These may be used alone or in combination of two or more thereof.

Examples of the silane coupling agent include a glycidyl group-containing silane coupling agent such as 2-(3,4-epoxycyclohexyl)ethyltrimethoxysilane, 3-glycidoxypropyltriethoxysilane, 3-glycidoxypropylmethyldimethoxysilane, 3-glycidoxypropyltrimethoxysilane or 3-glycidoxypropylmethyldiethoxysilane; a vinyl group-containing silane coupling agent such as vinyltris (β-methoxyethoxy) silane, vinyltriethoxysilane or vinyltrimethoxysilane; a (meth)acrylic group-containing silane coupling agent such as γ-methacryloxypropyltrimethoxysilane; an amino group-containing silane coupling agent such as N-β-(aminoethyl)-γ-aminopropyltrimethoxysilane, γ-aminopropyltriethoxysilane or N-phenyl-γ-aminopropyltrimethoxysilane; γ-mercaptopropyltrimethoxysilane, γ-chloropropyltrimethoxysilane, styrylsilane, ureidosilane, sulfidosilane and isocyanatesilane (except for component (B)). These may be used alone or in combination of two or more thereof. When a silane coupling agent is added, the amount thereof to be blended is preferably 0.1 to 20 parts by mass based on 100 parts by mass of component (A) of the present invention.

Examples of the active energy rays that cure the photocurable resin composition of the present invention include ultraviolet rays, visible light rays and laser light. The cumulative amount of light thereof is 1 to 100 KJ/m², preferably 5 to 70 KJ/m², and most preferably 10 to 50 KJ/m². Examples of the irradiation source of active energy rays include a high-pressure mercury lamp, an LED, an electrodeless lamp, a xenon lamp, a metal halide lamp, and sunlight.

The present invention is preferably cured at room temperature for 30 minutes to 14 days after irradiation with active energy rays. Thereafter, the composition irradiated with active energy rays advances in aging due to moisture, and therefore, a tough cured product can be obtained by aging for 30 minutes or more. The aging time is more preferably 1 to 10 days, and most preferably 5 to 8 days.

The resin cured product obtained by subjecting the photocurable resin composition of the present invention to a curing treatment has excellent resin strength, and can be used for various applications such as adhesion, sealing, casting, painting, a coating agent, and molding of optical parts. For specific applications, in the field of automobiles and transportation machines, it can be for adhesion, sealing, casting, molding, a coating agent and the like for an automobile switch, a headlamp, an engine internal part, an electrical part, a driving engine, a brake oil tank and the like. In the field of flat panel displays, it can be used for adhesion, sealing, casting, molding, a coating agent and the like for a liquid crystal display, an organic electroluminescence display, a light-emitting diode display and a field emission display. In the field of recording, it can be used for adhesion, sealing, casting, molding, a coating agent and the like for a video disk, a CD, a DVD, an MD, a pickup lens, a hard disk peripheral (a spindle motor member, a magnetic head actuator member and the like), a Blu-ray disk and the like. In the field of electronic materials, examples of the applications thereof include a sealing material for an electronic part, an electric circuit, an electric contact or a semiconductor element; a die bond agent, an electrically-conductive adhesive, an anisotropic electrically-conductive adhesive, an interlayer adhesive agent for a multilayer substrate including a build-up substrate, and solder resist. In the field of batteries, it can be used for adhesion, sealing, casting, molding, a coating agent and the like for a lithium battery, a manganese battery, an alkaline battery, a nickel battery, a fuel battery, a silicon-based solar battery, a dye-sensitized solar battery, an organic solar battery and the like. In the field of optical parts, it can be used for adhesion, sealing, casting, molding, a coating agent and the like for an optical switch peripheral in an optical communication system, an optical fiber material for an optical connector peripheral, an optical passive part, an optical circuit part, an opto-electronic integrated circuit peripheral and the like. In the field of optical instruments, it can be used for adhesion, sealing, casting, molding, coating and the like for a lens material, a finder prism, a target prism, a finder cover, a light-receiving sensor part and a photographic lens for a still camera, and a projection lens for a projection television, and the like. In addition, the photocurable resin composition of the present invention may also be used to fill gaps provided between a protective part such as glass and an image display part in an image display device such as a liquid crystal display or a touch panel display. In addition, the resin cured product obtained by subjecting the photocurable resin composition of the present invention to a curing treatment has excellent concealability due to the coloring agent and, therefore, can also be used for potting an electronic component and wiring.

### EXAMPLES

Hereinafter, the present invention will be described in more detail with reference to examples, but the present invention is not limited only to these examples.

Unless otherwise specified, tests were carried out in an environment of 25° C. and 55% RH.

### Examples 1 to 3 and Comparative Examples 1 to 4

The following components were provided to prepare the photocurable resin composition. Hereinafter, the photocurable resin composition will also be simply referred to as the composition.

Component (A): an organic polymer having two or more alkoxysilyl groups in one molecule
SAX530 (an organic polymer having a trimethoxysilyl group at each of both terminals and having a polyether skeleton; viscosity: 7 Pa·s; manufactured by KANEKA CORPORATION)
MA451 (a mixture of an organic polymer having a trimethoxysilyl group and a polyether skeleton and an organic polymer having a trimethoxysilyl group and an acrylic polymer skeleton; viscosity: 90 Pas; manufactured by KANEKA CORPORATION)
Component (B): a compound having an isocyanuric ring and an alkoxysilyl group in one molecule
KBM-9659 (tris (3-trimethoxysilylpropyl) isocyanurate; manufactured by Shin-Etsu Chemical Co., Ltd.) Component (B)′: compounds other than (B)
ARONIX M313 (isocyanuric acid ethylene oxide-modified triacrylate, manufactured by TOAGOSEI CO., LTD.)
KBM-9007 (3-isocyanatepropyltriethoxysilane, manufactured by Shin-Etsu Chemical Co., Ltd.) Component (C): a pigment
MV Black T-01 (a pigment: carbon black (25% by mass); a plasticizer: a phenyl alkylsulfonate ester (75% by mass); manufactured by Mikuni-Color Ltd.)
ZA Black 3026 (a pigment: carbon black (25% by mass); a plasticizer: a polyoxyalkylene alkyl ether (75% by mass); manufactured by Mikuni-Color Ltd.) Component (C)′: the other coloring agent
elixaBlack 850 (aromatic black dye, manufactured by ORIENT CHEMICAL INDUSTRIES CO., LTD.) Component (D): a photoacid generator.
CPI-200K (a photoacid generator: diphenyl [4-(phenylsulfanyl)phenyl] sulfonium trifluorotris (pentafluoroethyl)-25-phosphanuide (50% by mass); a solvent: propylene carbonate (50% by mass) manufactured by San-Apro Ltd.).

The method for producing the composition according to each of Examples 1 to 3 and Comparative Examples 1 to 4 was as follows. Components (A), component (B) (or component (B)′), component (C) (or component (C)′), and component (D) were weighed out and stirred at ordinary temperature under light shielding for 30 minutes with a planetary mixer. The mixture was further stirred for 30 minutes with a planetary mixer with vacuum degassing to obtain a photocurable resin composition. The obtained photocurable resin composition was liquid at 25° C. Detailed amounts used in the preparation are shown in Table 1, and all values are expressed in parts by mass.

### <Surface Curability Test>

The composition was coated on the entire surface of a SUS304 plate having a thickness of 1.6 mm×a width of 25 mm×a length of 100 mm to a thickness of 1 mm, and was irradiated with ultraviolet rays with a cumulative amount of light of 30 kJ/m² using a belt conveyor type UV-LED irradiation device. Thereafter, it was aged and cured in an environment of 23° C. and 50% RH for one week. After the aging, the surface of the cured product was touched with a fingertip cleaned with alcohol to check for the presence or absence of tack, and evaluated according to the following evaluation criteria. Considering the pollution on the surrounding area during machining, in the present invention, as little tack as possible is preferably observed. Therefore, Δ or O are preferred, and O is most preferred. The symbol “-” in the test results means that the composition was separated and a uniform test piece could not be prepared therefrom.

### [Evaluation Criteria]

O: No fingerprints were left on the surface of the cured product.
φ: Fingerprints were left on the surface of the cured product.
x: Resin adheres to fingers.

### <Measurement of Total Light Transmittance>

The composition was coated on the entire surface of an alkali-free glass plate having a thickness of 0.7 mm×a width of 50 mm×a length of 50 mm to a thickness of 30 μm, and irradiated with ultraviolet rays with a cumulative amount of light of 30 KJ/m² using a belt conveyor type UV-LED irradiation device. Thereafter, it was aged and cured in an environment of 23° C. and 50% RH for one week. After the aging, total light transmittance was measured with a spectral haze meter SH7000 manufactured by Nippon Denshoku Industries Co., Ltd. The light transmittance thereof was measured in the wavelength range of 780 nm to 380 nm. The number of tests was n=3, and the average value was calculated and evaluated according to the following evaluation criteria. For details, JIS K 7361-1:1997 was followed. From the viewpoint of concealability, the rating of O is preferred. The symbol “-” in the test results means that the composition did not cure and a test piece could not be prepared therefrom.

### [Evaluation Criteria]

O: Total light transmittance of 0.1% or less
X: Total light transmittance of more than 0.1%<

### Tensile Strength Test>

The composition was poured into an area surrounded by jigs set so that the composition has a thickness of 0.5 mm×a width of 200 mm× a length of 200 mm, irradiated with ultraviolet rays with a cumulative amount of light of 30 kJ/m² using a belt conveyor type UV-LED irradiation device, and then aged and cured in an environment of 23° C. and 50% RH for one week. The obtained cured product was cut into strips having a thickness of 0.5 mm×a width of 10 mm×a length of 60 mm to prepare test pieces. Each of the test pieces prepared were fixed to the chuck at both ends so that the long axis of the test piece and the center of the chuck were aligned, and pulled at a rate of pulling of 50 mm/min with a universal tensile tester to measure the maximum load. The strength at the maximum load is defined as the “tensile strength (MPa)”. The results are shown in Table 1. For details, JIS K 6251 (2010) was followed. In the present invention, the tensile strength of the cured product is preferably 0.4 MPa or more, and more preferably 0.6 MPa or more, from the viewpoint of excellent resistance to cracking of the resin due to vibration, impact, or the like. The upper limit value in the present test is not particularly limited, but it is preferably 3.0 MPa or less, and more preferably 1.0 MPa or less. The symbol “-” in the test results means that the composition did not cure and a test piece could not be prepared, or that the composition was poor in concealability and the measurement was not performed.

TABLE 1

| | | Example | Example | Example | Comparative | Comparative | Comparative | Comparative |
|---|---|---|---|---|---|---|---|---|
| | | 1 | 2 | 3 | Example 1 | Example 2 | Example 3 | Example 4 |
| Component | SAX530 | 72 | 72 | 72 | 72 | 72 | 72 | 72 |
| (A) | MA451 | 28 | 28 | 28 | 28 | 28 | 28 | 28 |
| Component | KBM-9659 | 10 | 5 | 10 | | | | |
| (B) | | | | | | | | |
| Component | ARONIX M313 | | | | 10 | | | |
| (B)′ | KBM-9007 | | | | | 10 | | |
| Component | MV Black T-01 | 20 | 20 | | 20 | 20 | 20 | |
| (C) | ZA Black 3026 | | | 20 | | | | |
| Component | elixaBlack850 | | | | | | | 5 |
| (C)′ | | | | | | | | |
| Component | CPI-200K | 3 | 3 | 3 | 3 | 3 | 3 | 3 |
| (D) | | | | | | | | |

| | | | | | | | |
|---|---|---|---|---|---|---|---|
| Total amount | 133 | 128 | 133 | 133 | 133 | 123 | 108 |
| Surface Curability | ◯ | ◯ | ◯ | Δ | X | Δ | ◯ |
| Total light | ◯ | ◯ | ◯ | ◯ | ◯ | ◯ | X |
| transmittance | | | | | | | |
| Tensile strength (MPa) | 0.6 | 0.4 | 0.6 | 0.3 | — | 0.3 | — |

It was confirmed that the compositions in Examples 1 to 3, containing Components (A) to (D), had excellent surface curability and tensile strength. In contrast, the composition in Comparative Example 1, containing a compound containing an isocyanuric ring and no alkoxysilyl group instead of component (B), had poor surface curability and tack was observed in the cured product. It was confirmed that the composition in Comparative Example 1 was poorer in tensile strength than that in Example 1 and provided the cured product that was prone to cracking. The composition in Comparative Example 2, in which component (B) was changed to a compound having an isocyanate group and an alkoxysilyl group, was poor in curability and a cured product could not be prepared therefrom. The composition in Comparative Example 3, containing no component (B), was poor in surface curability and tack was observed in the cured product. It was confirmed that the composition in Comparative Example 3 was poor in tensile strength and provided the cured product that was prone to cracking. The composition in Comparative Example 4, containing a dye instead of component (C), had high total light transmittance and could not provide sufficient concealability.

The present application is based on Japanese Patent Application No. 2022-199425 filed on Dec. 14, 2022, the disclosure content of which is incorporated by reference in its entirety.

### INDUSTRIAL APPLICABILITY

In recent years, plastics are often used as members for electrical and electronic parts. Since plastics are inferior to metals in heat resistance, it is desired to apply as little heat as possible to plastics. The present invention is a photocurable resin composition that does not require heat during curing, and has excellent surface curability and strength even when colored. Due to these properties, the present invention can be used for assembling and potting various electrical and electronic parts, and has the potential to be developed for a wide range of applications.

1. A photocurable resin composition comprising the following components (A) to (D):
component (A): an organic polymer having two or more alkoxysilyl groups in one molecule;
component (B): a compound having an isocyanuric ring and an alkoxysilyl group in one molecule;
component (C): a pigment; and
component (D): a photoacid generator.

2. The photocurable resin composition according to claim 1, wherein the component (A) comprises an organic polymer having a polyether skeleton and having two or more alkoxysilyl groups in one molecule.

3. The photocurable resin composition according to claim 1, wherein the component (A) comprises an organic polymer having a polyether skeleton and having two or more alkoxysilyl groups in one molecule and an organic polymer having a vinyl-based polymer skeleton and having two or more alkoxysilyl groups in one molecule.

4. The photocurable resin composition according to claim 1, wherein the component (C) is carbon black.

5. The photocurable resin composition according to claim 1, wherein the component (D) is an onium salt compound.

6. The photocurable resin composition according to claim 1, wherein the component (D) is a sulfonium salt compound.

7. The photocurable resin composition according to claim 1, wherein the component (B) is tris(3-trimethoxysilylpropyl) isocyanurate.

8. A cured product obtained by curing the photocurable resin composition according to claim 1.

9. The cured product according to claim 8, having a total light transmittance of 0.1% or less and a tensile strength of 0.4 MPa or more.
